(19) United States
(12) Patent Application Publication
(10) Pub. No.: US 2025/0162325 A1
(43) Pub. Date: May 22, 2025

(54) LIQUID SUPPLY APPARATUS

(71) Applicant: CANON KABUSHIKI KAISHA, Tokyo (JP)

(72) Inventors: TOSHIMITSU DANZUKA, Tokyo (JP); RIE TAKEKOSHI, Kanagawa (JP); AKIHIRO TOMIDA, Kanagawa (JP); KEITA ISHIMI, Kanagawa (JP); AKIKO AICHI, Tokyo (JP); HIROTO KANGO, Tokyo (JP)

(21) Appl. No.: 18/946,252

(22) Filed: Nov. 13, 2024

(30) Foreign Application Priority Data
Nov. 21, 2023 (JP) 2023-197727

(51) Int. Cl. B41J 2/175; B41J 29/00

(52) U.S. Cl. CPC B41J 2/17566; B41J 29/00; B41J 2002/17573

(57) ABSTRACT

A liquid supply apparatus includes a deformable liquid containing member configured to contain a liquid to be supplied to a liquid discharge head for discharging the liquid to a recording medium, a liquid supply flow path for supplying the liquid to the liquid discharge head from the liquid containing member, a liquid retaining chamber disposed on the liquid supply flow path and configured to let the liquid flow into the liquid discharge head from the liquid containing member, a liquid draw-in unit configured to draw the liquid into the liquid retaining chamber from the liquid containing member, a pressing unit configured to press the liquid containing member from the outside, and a control unit configured to perform a control to display a first display or a second display on a display unit based on a volume of the liquid retaining chamber.

### BACKGROUND

### Field

The present disclosure relates to a liquid supply apparatus.

### Description of the Related Art

There has been known liquid supply apparatuses which supply liquid to liquid discharge heads for discharging liquid to recording media, as one type of liquid supply apparatuses. In the above-described liquid supply apparatuses, a method is employed for replacing a container called an ink tank as a replenishment with ink decreased by ink consumption. This container is provided detachable in a printer, and ink is contained in the container. Further, for example, as a type of the above-described container, a bag-shaped container called an ink pack is used. The volume of this container varies because at least a part of the container is made of material with flexibility. Japanese Patent No. 5448041 discusses a method for calculating the amount of ink remaining in the ink pack based on a soft count.

The soft count is a method for calculating the amount of ink consumption. In this method, generally, the amount of ink droplets discharged and the amount of ink sucked and discharged from ink discharge ports are previously measured. The amount of ink consumption is calculated by multiplying these measured values by the number of ink droplets discharged and the number of times of suction/discharge. However, the amount of ink droplets discharged and the amount of sucked/discharged ink vary depending on the state of the ink jet printer or the installation environment of the printer. This can cause some error in calculation of the amount of ink consumption based on the method disclosed in Japanese Patent No. 5448041.

### SUMMARY

The present disclosure is directed to a method for detecting the amount of ink contained in an ink pack more accurately.

According to an aspect of the present disclosure, a liquid supply apparatus includes a deformable liquid containing member configured to contain a liquid to be supplied to a liquid discharge head for discharging the liquid to a recording medium, a liquid supply flow path for supplying the liquid to the liquid discharge head from the liquid containing member, a liquid retaining chamber disposed on the liquid supply flow path and configured to let the liquid flow into the liquid discharge head from the liquid containing member by changing a volume of the liquid containing member, a liquid draw-in unit configured to draw the liquid into the liquid retaining chamber from the liquid containing member by reducing a pressure of a space outside the liquid retaining chamber to cause the volume of the liquid retaining chamber to be expanded, a pressing unit configured to press the liquid containing member from the outside, and a control unit configured to perform a control to display a first display on a display unit in a case where the volume of the liquid retaining chamber is less than a predetermined amount when the pressing unit presses the liquid containing member, and to display a second display on the display unit in a case where the volume of the liquid retaining chamber is less than the predetermined amount when the liquid draw-in unit reduces a pressure of the space.

Further features of the present disclosure will become apparent from the following description of exemplary embodiments with reference to the attached drawings.

### BRIEF DESCRIPTION OF THE DRAWINGS

FIG. 1 is a schematic diagram illustrating a recording apparatus to which a liquid supply apparatus is applied according to a first exemplary embodiment.

FIG. 2 is a block diagram illustrating a control system of the recording apparatus according to the first exemplary embodiment.

FIGS. 3A to 3E are schematic diagrams each illustrating the recording apparatus executing a sequence of detecting the amount of remaining ink according to the first exemplary embodiment.

FIG. 4 is a flowchart illustrating the sequence of detecting the amount of remaining ink according to the first exemplary embodiment.

FIGS. 5A and 5B are a flowchart illustrating a sequence of detecting the amount of remaining ink according to a second exemplary embodiment.

FIG. 6 is a schematic diagram illustrating a recording apparatus to which a liquid supply apparatus is applied according to a third exemplary embodiment.

FIG. 7 is a flowchart illustrating a sequence of ink agitation according to the third exemplary embodiment.

### DESCRIPTION OF THE EMBODIMENTS

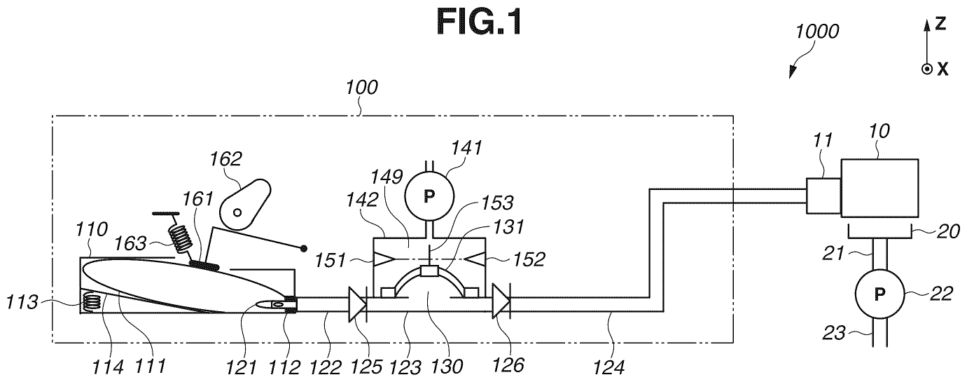

A first exemplary embodiment will be described. FIG. 1 is a schematic diagram illustrating an ink jet recording apparatus (hereinafter, a recording apparatus 1000) as one example of an apparatus to which a liquid supply apparatus is applied according to the present disclosure. A recording head 10 includes discharge ports from which ink as a liquid is discharged to a recording medium. The recording head 10 records images and characters on a recording medium by discharging ink from the discharge ports to the recording medium. The recording head 10 includes a negative pressure regulator 11. A valve is closed when a negative pressure within the recording head 10 is a predetermined value or less, and is opened to let ink flow into the recording head 10 when the negative pressure within the recording head 10 is greater than the predetermined value.

A cap 20 is a cap mechanism movable in the positive and negative Z directions in FIG. 1 with a driving mechanism (not illustrated). The cap 20 can be moved between a capping position where the cap 20 comes into contact with the surface on the discharge ports of the recording head 10 to cover (cap) the discharge ports and a separation position where the cap 20 is separated from the surface on the discharge ports and exposes the discharge ports. FIG. 1 illustrates a state where the cap 20 is in the separation position. A suction pump 22 is connected to the cap 20 via a cap tube 21, so that ink can be sucked from the discharge ports when the suction pump 22 is driven. The ink sucked from the discharge ports by the driving of the suction pump 22 is sent to a waste ink tank (not illustrated) via a waste ink tube 23 connected to the suction pump 22, and retained in the waste ink tank.

An ink supply apparatus 100 included in the recording apparatus 1000 will be described. An ink pack 110 is detachably mounted through a configuration (not illustrated) on the recording apparatus 1000 of the present exemplary embodiment. An ink bag 111 serving as a liquid containing member for containing ink is housed in the ink pack 110. A rubber plug 112 is arranged on the ink bag 111. A hollow ink supply needle 121 pierces through the rubber plug 112 when the ink pack 110 is installed into the recording apparatus 1000 of the present disclosure. When the rubber plug 112 is pierced by the ink supply needle 121, ink contained in the ink bag 111 can flow into a first ink supply flow path (a first liquid supply flow path) 122. In addition, the ink bag 111 alone can be detachably mounted to the recording apparatus 1000 instead of the ink pack 110 installed into the recording apparatus 1000.

A flexible member is used as at least a part of the ink bag 111. Thus, the ink bag 111 can be deformed based on the amount of ink contained in the ink bag 111 or by a pressure applied from the outside. FIG. 1 illustrates a state of the brand-new (unused) ink pack 110, where a maximum amount of containable ink is contained in the ink bag 111. In the present exemplary embodiment, the brand-new ink pack 110 contains approximately 1,000 ml of ink.

The ink bag 111 is placed on an inclined plate 114 when the ink pack 110 is mounted on the recording apparatus 1000. While the inclined plate 114 is pushed upward by a push-up spring 113 in the positive Z direction in FIG. 1, the position of the inclined plate 114 is restricted by a stopper (not illustrated). As a result, the inclined plate 114 is not pushed beyond a predetermined position. The predetermined position, for example, corresponds to a position at which the upper surface of the brand-new ink bag 111 is in contact with the inner surface of the ink pack 110.

An ink retaining chamber 130 is arranged on a second ink supply flow path (a second liquid supply flow path) 123 which communicates with the first ink supply flow path 122 connected to the ink supply needle 121. The ink retaining chamber 130 partially includes a flexible portion 131, and the flexible portion 131 is made of a flexible member, such as a rubber member. Due to the flexible portion 131, the volume of the ink retaining chamber 130 can vary with the driving of a draw-in pump 141 described below. FIG. 1 illustrates the ink retaining chamber 130 with a maximum volume. In the present exemplary embodiment, the maximum volume of the ink retaining chamber 130 is 1.5 ml. A stopper is arranged on the ink retaining chamber 130, so that the volume of the ink retaining chamber 130 is not greater than a predetermined maximum volume.

According to the present exemplary embodiment, less flow path resistance is generated when the ink in the ink retaining chamber 130 is supplied to the recording head 10 than when the ink contained in the ink bag 111 is supplied to the recording head 10 via the second ink supply flow path 123. The flow path resistance can be adjusted, for example, by making the flow path diameter of the second ink supply flow path 123 larger than that of the first ink supply flow path 122, or by limiting the amount of ink flowing into the ink retaining chamber 130 through the first ink supply flow path 122.

When ink is used and discharged from the discharge ports of the recording head 10 in the state of FIG. 1, the flexible portion 131 is deformed toward the second ink supply flow path 123, which decreases the volume of the ink retaining chamber 130. The ink retaining chamber 130 is arranged inside a partition wall 142, and the draw-in pump 141 is connected to the partition wall 142. The outer circumference of a space 149 is covered by the partition wall 142 and the ink retaining chamber 130, and air in the space 149 between the ink retaining chamber 130 and the partition wall 142 is sucked to be discharged by the draw-in pump 141 when it is driven. In other words, the draw-in pump 141 depressurizes the space around the ink retaining chamber 130. The draw-in pump 141 is open to the atmosphere when not driven. At this time, the space 149 communicates with the atmosphere, and is kept at the atmospheric pressure.

When air in the space 149 is sucked and discharged, the space 149 is depressurized and kept at a negative pressure. The effect of the negative pressure pulls the flexible portion 131 upward in FIG. 1, and the volume of the ink retaining chamber 130 expands accordingly. At this time, if ink remains sufficient for expansion of the volume of the ink retaining chamber 130 in the ink bag 111, the ink flows into the ink retaining chamber 130 to cause the volume of the ink retaining chamber 130 to be expanded to a maximum volume. In other words, the draw-in pump 141 is driven to draw ink into the ink retaining chamber 130 from the ink bag 111.

A check valve 125 is arranged at a position between the first ink supply flow path 122 and the second ink supply flow path 123. While ink is allowed to flow into the second ink supply flow path 123 through the first ink supply flow path 122, the flow of ink from the second ink supply flow path 123 to the first ink supply flow path 122 is regulated by the check valve 125. Further, a check valve 126 is arranged at a position between the second ink supply flow path 123 and a third ink supply flow path 124 for allowing the second ink supply flow path 123 to communicate with the negative pressure regulator 11. While ink is allowed to flow into the third ink supply flow path 124 through the second ink supply flow path 123, the flow of ink from the third ink supply flow path 124 to the second ink supply flow path 123 is regulated by the check valve 126. With the functions of the check valves 125 and 126, when ink flows into the ink retaining chamber 130, the ink flow path is limited to the path for letting the ink flow into the ink retaining chamber 130 through the first ink supply flow path 122.

A photo-interrupter including a light emitting unit 151 and a light receiving unit 152 is arranged inside the partition wall 142. A light blocking plate 153 which reciprocates in the positive and negative Z directions in FIG. 1 with increase and decrease in the volume of the ink retaining chamber 130 is arranged on the flexible portion 131 of the ink retaining chamber 130. As described above, the light blocking plate 153 and the photo-interrupter are provided as main constituent elements to constitute a detection sensor which detects whether the volume of the ink retaining chamber 130 is a predetermined volume or more.

The detection sensor detects whether the volume of the ink retaining chamber 130 is a predetermined volume or more based on whether light emitted from the light emitting unit 151 is received by the light receiving unit 152, or, whether light is blocked by the light blocking plate 153. In the present exemplary embodiment, the volume of the ink retaining chamber 130 when the light blocking plate 153 starts blocking the light emitted from the light emitting unit 151, i.e., the predetermined volume, is 1 ml. Further, the volume of the ink retaining chamber 130 when the ink retaining chamber 130 is most shrunk is 0.5 ml.

When the volume of the ink retaining chamber 130 expands to 1 ml or more, light emitted from the light emitting unit 151 is blocked by the light blocking plate 153. When the volume of the ink retaining chamber 130 is less than 1 ml, light emitted from the light emitting unit 151 is not blocked by the light blocking plate 153. When the volume of the ink retaining chamber 130 is a predetermined volume or more, the above-described configuration can determine that ink remains as the light receiving unit 152 does not receive light since the light emitted from the light emitting unit 151 is blocked by the light blocking plate 153. Further, when the volume of the ink retaining chamber 130 is less than a predetermined volume, the small amount of remaining ink can be detected as the light receiving unit 152 receives light since the light emitted from the light emitting unit 151 is not blocked by the light blocking plate 153. Through the above-described configuration, the detection sensor can detect whether the volume of the ink retaining chamber 130 is a predetermined volume or more.

The predetermined volume can be set as appropriate depending on the product size or the maximum volume of the ink bag 111.

A pressing mechanism including a pressing plate 161, a rotating cam 162, and a pressure releasing spring 163 is arranged in the ink supply apparatus 100. This pressing mechanism presses the ink bag 111 when the rotating cam 162 is located at the top dead point. Then, when the rotating cam 162 is positioned at the bottom dead point, the pressing mechanism releases the pressure to the ink bag 111 with the restoring force of the pressure releasing spring 163. The rotating cam 162 is rotated with the rotation of a pressing motor (not illustrated). In FIG. 1, the rotating cam 162 is positioned at the bottom dead point. The pressing plate 161 has a width substantially the same as that of the ink bag 111 (a width in the X direction in FIG. 1). When the ink bag 111 contains a maximum amount of ink, the pressing mechanism according to the present exemplary embodiment does not completely flatten the ink bag 111 even if the rotating cam 162 is positioned at the top dead point.

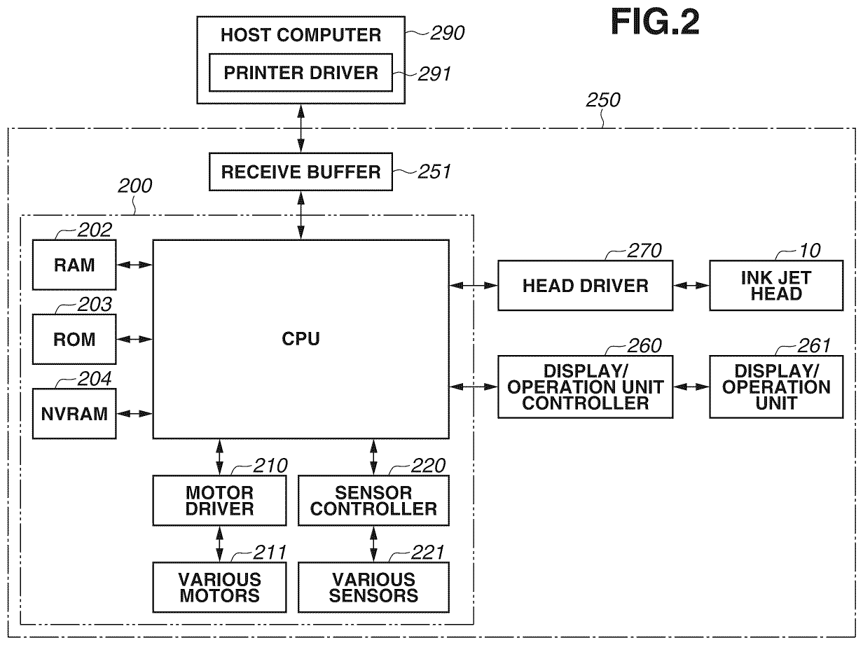

A control system of the recording apparatus 1000 will now be described with reference to a block diagram illustrated in FIG. 2.

A block diagram 250 illustrates a control system of the recording apparatus 1000 according to the present exemplary embodiment, and a block diagram 200 illustrates a control system of the ink supply apparatus 100. The recording apparatus 1000 is connected to a host computer 290 via a universal serial bus (USB) interface (not illustrated). The host computer 290 includes a printer driver 291 stored as software. Based on a printing instruction issued by a user, the printer driver 291 generates print data from image data, such as documents and photos, desired by the user, and transmits the print data to the recording apparatus 1000 of the present disclosure.

A receive buffer 251 retains the print data transmitted to the recording apparatus 1000 from the host computer 290. The print data retained in the receive buffer 251 is transmitted to and temporarily stored in a random access memory (RAM) 202 under the control of a central processing unit (CPU) 201. A read only memory (ROM) 203 stores programs and fixed data for various types of control executed by the recording apparatus 1000. A non-volatile RAM (NVRAM) 204 is a non-volatile memory for saving information which is stored even if the power of the recording apparatus 1000 is turned off.

A motor driver 210 performs driving control of various motors 211, such as motors for driving the draw-in pump 141 and the suction pump 22, a motor for rotating the rotating cam 162, and a motor for moving the cap 20 up and down. Further, a sensor controller 220 controls various sensors 221 including the above-described detection sensor.

The recording apparatus 1000 according to the present exemplary embodiment includes a display unit and an operation unit which are not illustrated. The display unit displays various types of information about the recording apparatus 1000, and instructions are input by the user via the operation unit. A display/operation unit controller 260 controls a display/operation unit 261. Further, a head driver 270 performs driving control on the recording head 10. The CPU 201 implements various types of processing, such as arithmetic processing, control processing, determination processing, and setting processing, together with the RAM 202, the ROM 203, and the NVRAM 204.

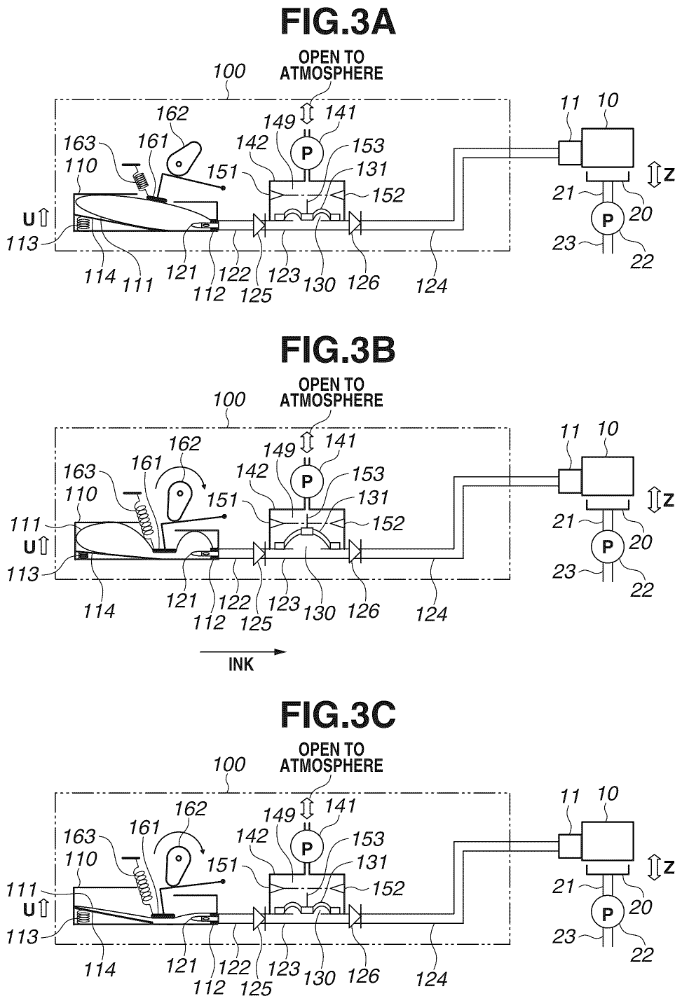

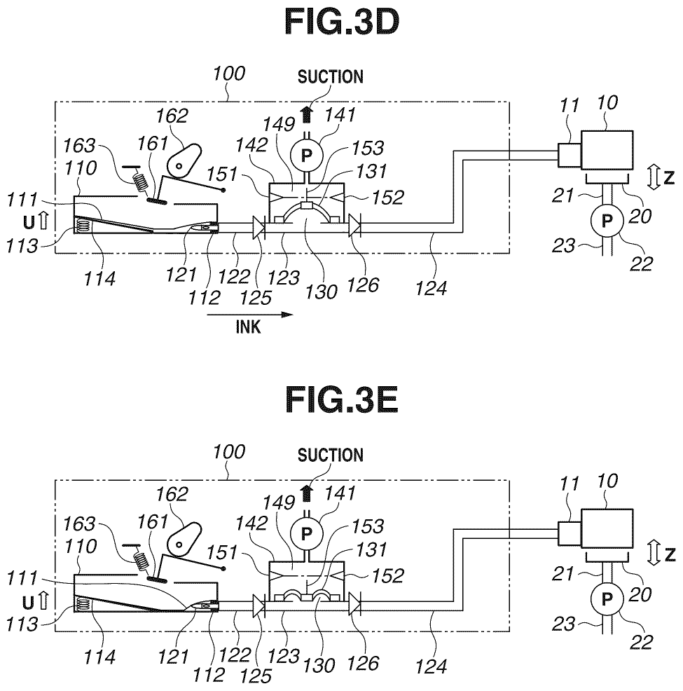

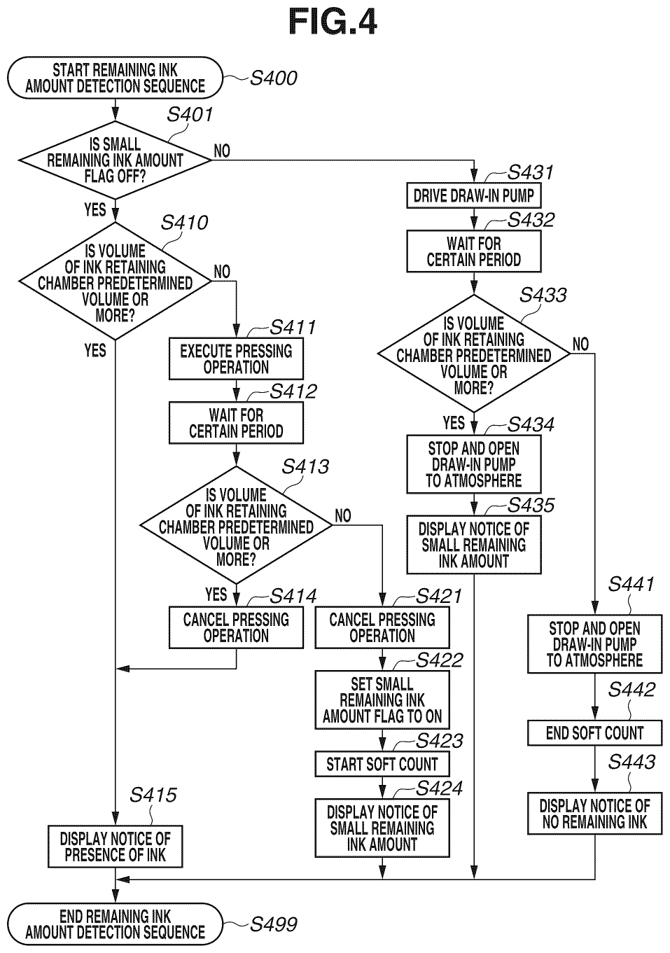

A sequence of detecting the amount of remaining ink according to the present exemplary embodiment will now be described with reference to FIGS. 3A to 3E and FIG. 4. FIGS. 3A to 3E are schematic diagrams each illustrating the recording apparatus 1000 executing the sequence of detecting the amount of remaining ink, and FIG. 4 is a flowchart illustrating the sequence of detecting the amount of remaining ink. In FIGS. 3A to 3E, like numbers refer to like elements illustrated in FIG. 1, and the descriptions thereof are omitted. The sequence of detecting the amount of remaining ink is executed before an operation consuming ink is started, such as an operation for discharging ink from the discharge ports of the recording head 10.

In step S400, when the sequence of detecting the amount of remaining ink is started, firstly, the processing proceeds to step S401. In step S401, the processing is performed for determining whether a flag indicating a small amount of remaining ink is off. While the details will be described below, the flag indicating the small amount of remaining ink is on only when a small amount of ink remaining in the ink pack 110 is detected in the sequence of detecting the amount of remaining ink. First, the present exemplary embodiment will be described with a case where a substantially brand-new ink pack 110 is installed into the recording apparatus 1000 of the present disclosure. When the brand-new ink pack 110 is installed into the recording apparatus 1000, the flag indicating the small amount of remaining ink is off. Thus, the determination result in step S401 is “YES” (YES in step S401), and the processing proceeds to step S410.

In step S410, the processing is performed for determining whether the volume of the ink retaining chamber 130 is a predetermined volume or more by using the detection sensor described above. As described above, operations with ink consumption, such as operations for discharging ink from the ink discharge ports of the recording head, reduce the volume of the ink retaining chamber 130. Thus, in many cases, the volume of the ink retaining chamber 130 is less than the above-described predetermined volume. The sequence of detecting the amount of remaining ink will be described with a case where the determination result in step S410 is “NO”, i.e., when the volume of the ink retaining chamber 130 is less than the above-described predetermined volume. If the determination result in step S410 is “NO”, the recording apparatus 1000 is brought into a state illustrated in FIG. 3A, where the volume of the ink retaining chamber 130 is reduced most.

If the volume of the ink retaining chamber 130 is less than the predetermined volume, the determination result in step S410 is “NO” (NO in step S410), and the processing proceeds to step S411. In step S411, a pressing operation is performed with the pressing mechanism described above. Specifically, the pressing mechanism causes the rotating cam 162 to be rotated by a half turn from the bottom dead point to the top dead point, pressing the ink bag 111 with the pressing plate 161. In step S412, a waiting time takes a certain period of time. Then, the processing proceeds to step S413. In step S413, the processing is performed for determining whether the volume of the ink retaining chamber 130 is the predetermined volume or more again by using the detection sensor. In addition, in step S412, the waiting time is taken for 0.5 seconds. However, the length of the waiting time can be set as appropriate.

If the volume of the ink retaining chamber 130 is a predetermined volume or more when the ink is pushed out of the ink bag 111 by the pressing operation performed in step S411, e.g., the determination result in step S413 is “YES” (YES in step S413), the processing proceeds to step S414. At this time, the recording apparatus 1000 is brought into the state illustrated in FIG. 3B.

In step S414, the pressing mechanism releases the pressure on the ink bag 111. Specifically, the pressing mechanism causes the rotating cam 162 to be rotated by a half turn from the top dead point to the bottom dead point, which releases the pressure on the ink bag 111. At this time, the recording apparatus 1000 is brought into the state in FIG. 1.

After the processing in step S414, the processing proceeds to step S415. In step S415, a notification of a sufficient amount of ink in the ink pack 110 is displayed on the display unit of the recording apparatus 1000 of the present disclosure. Then, in step S499, the sequence of detecting the amount of remaining ink is ended.

On the other hand, if the volume of the ink retaining chamber 130 is less than the predetermined volume even with the pressing operation performed in step S411, e.g., a determination result in step S413 is “NO” (NO in step S413), the processing proceeds to step S421. if the volume of the ink retaining chamber 130 is not the predetermined volume or more even with the pressing operation performed, that means that ink contained in the ink bag 111 is hardly pushed out into the ink retaining chamber 130. In other words, a small amount of ink remains in the ink bag 111. At this time, the recording apparatus 1000 is brought into the state illustrated in FIG. 3C, and the amount of ink remaining in the ink bag 111 is approximately 100 ml to 200 ml. In step S421, similarly to the processing in step S414, the pressure on the ink bag 111 by the pressing mechanism is released.

After the processing in step S421 ends, the processing proceeds to step S422, and the flag indicating a small amount of remaining ink is set to on. In step S423, soft count is started. The soft count is a method for calculating the amount of ink consumption. In this method, the amount of liquid discharged from the discharge ports per ink droplet and the amount of ink sucked to be discharged from the discharge ports by the suction pump 22 are previously measured and stored in the ROM 203, and the amount of ink consumption is calculated by multiplying these measured values by the number of discharged ink droplets and the number of times of suction/discharge. However, the amount of ink droplets discharged from the discharge ports and the amount of ink sucked/discharged vary depending on the state of the ink jet printer or the installation environment of the printer. Thus, the accuracy of the soft count is not so high, and the value of the soft count has an error of ±15%.

When the flag indicating a small amount of remaining ink is on and the brand-new ink pack 110 is installed into the recording apparatus 1000, the flag indicating a small amount of remaining ink is switched to off. The use information about the ink pack 110 is written into a chip (not illustrated) on the ink pack 110 from a reading/writing unit (not illustrated) of the recording apparatus 1000. The recording apparatus 1000 determines the use information about the ink pack 110 with the information read from the chip through the reading/writing unit.

In addition, as the count value of the soft count, “100 ml” is stored in predetermined areas (soft counters) of the RAM 202 and the NVRAM 204 at the time when the processing starts in step S423. When most of the ink in the ink pack 110 is used in the middle of the operation consuming ink, an ink discharge failure occurs at the discharge ports. To avoid this situation, “100 ml” is stored as a minimum value of the amount of ink remaining in the ink bag 111.

After the processing in step S423 ends, in step S424, a notification of a small amount of ink remaining in the ink pack 110 is displayed on the display unit of the recording apparatus 1000 of the present disclosure. In step S499, the sequence of detecting the amount of remaining ink is ended.

If an operation consuming ink is performed after the sequence of detecting the amount of remaining ink is ended, the amount of ink consumed during the operation is calculated with the soft count, and the count value stored in the soft counters is updated to a new one by subtracting the value of the calculated amount of ink consumption from the stored count value.

If the volume of the ink retaining chamber 130 is determined to be the predetermined volume or more, e.g., the determination result in step S410 is “YES” (YES in step S410), the processing proceeds to step S415. In step S415, a notification of a sufficient amount of remaining ink is displayed on the display unit of the recording apparatus 1000. In step S499, the sequence of detecting the amount of remaining ink is ended.

The sequence of detecting the amount of remaining ink will be described with a case where the determination result in step S401 is “NO”. In step S401, if the flag indicating a small amount of remaining ink is on (NO in step S401), the processing proceeds to step S431. In step S431, the driving of the draw-in pump 141 is started. When the driving of the draw-in pump 141 is started, a waiting time takes a certain period of time in step S432. Then, the processing proceeds to step S433. In step S433, the processing is performed for determining whether the volume of the ink retaining chamber 130 is a predetermined volume or more with the detection sensor again. In addition, in step S432, a waiting time takes 1.0 seconds. However, the length of the waiting time can be set as appropriate.

If the volume of the ink retaining chamber 130 is a predetermined volume or more when the ink in the ink bag 111 is sucked by the driving of the draw-in pump 141 in step S431, e.g., the determination result in step S433 is “YES” (YES in step S433), the processing proceeds to step S434. At this time, the recording apparatus 1000 is brought into the state illustrated in FIG. 3D. In step S434, the driving of the draw-in pump 141 started in step S431 is stopped. As described above, when the driving of the draw-in pump 141 is stopped, the space 149 communicates with the atmosphere.

After the processing in step S434 ends, the processing proceeds to step S435. In step S435, a notification of the small amount of remaining ink is displayed on the display unit of the recording apparatus 1000. In step S499, the sequence of detecting the amount of remaining ink is ended. If the operation consuming ink is to be executed after the sequence of detecting the amount of remaining ink, the processing is started for checking whether the amount of ink consumed during the operation exceeds the count value stored in the soft counters before the operation. If the value of the amount of ink consumed exceeds the count value, the operation is not to be started.

Further, a notification of almost no amount of ink in the ink pack 110 is displayed on the display unit of the recording apparatus 1000 of the present disclosure. Hereinafter, the notification of almost no amount of ink in the ink pack 110 is also referred to “notification of no remaining ink”. In the present exemplary embodiment, the operation with the highest ink consumption is a recovery operation for the discharge performance of the recording head 10 to be recovered most powerfully, and the amount of ink consumed in the recovery operation is 7 ml.

If the volume of the ink retaining chamber 130 is less than the predetermined volume even with the driving of the draw-in pump 141 executed in step S431, e.g., the determination result in step S433 is “NO” (NO in step S433), the processing proceeds to step S441. The fact that the volume of the ink retaining chamber 130 is not the predetermined volume or more even with the draw-in pump 141 driven means that the ink in the ink bag 111 is hardly sucked to the ink retaining chamber 130 by the driving of the draw-in pump 141. In other words, almost no ink remains in the ink bag 111. At this time, the recording apparatus 1000 is brought into the state illustrated in FIG. 3E.

In step S441, the driving of the draw-in pump 141 is stopped, and the space 149 communicates with the atmosphere. After the processing in step S441, the processing proceeds to step S442. In step S442, the soft count started in step S423 is ended. After the soft count is ended, the processing proceeds to step S443. In step S443, the notification of no remaining ink is displayed on the display unit of the recording apparatus 1000. In step S499, the sequence of detecting the amount of remaining ink is ended.

In the present exemplary embodiment, a small amount of ink remaining in the ink pack 110 can be detected through the above-described configuration. The above-described detection can minimize the amount of ink remaining in the ink pack 110 when the notification of no remaining ink is displayed. A specific effect of the present exemplary embodiment will be described.

The maximum value of the amount of ink remaining in the ink pack 110 when the notification of no remaining ink is displayed is calculated if the soft count alone is performed without detection of a small amount of ink remaining in the ink pack 110. As described above, the brand-new ink pack 110 contains approximately 1,000 ml of ink. More specifically, the brand-new ink pack 110 contains 1,000 ml±2% of ink, i.e., 980 ml to 1,020 ml of ink.

In the recording apparatus 1000 according to the present exemplary embodiment, the operation consuming ink the most is the recovery operation that powerfully recovers the discharge performance of the recording head 10, and the amount of ink consumed in the recovery operation is 7 ml. The recovery operation is not instantly stopped halfway through. Thus, if the amount of ink remaining in the ink pack 110 is less than 7 ml, the recovery operation is not started even when the CPU 201 issues an instruction for performing the recovery operation, which will consume 7 ml of ink. In this case, the notification of no remaining ink is displayed on the display unit of the recording apparatus 1000.

The soft count is performed in consideration of the lower-limit within the error of the amount of ink in the brand-new ink pack 110 and the amount of ink consumed during the above-described recovery operation. Thus, when the brand-new ink pack 110 is installed into the recording apparatus 1000, the amount of ink consumable based on the soft count is 973 ml (980 ml−7 ml=973 ml) at its minimum of the amount of ink in the brand-new ink pack 110.

As described above, since the value counted by the soft count can have an error of ±15%, the maximum value of the tolerance is used when the amount of ink consumed in an operation is calculated. This is because an ink discharge failure can occur at the discharge ports when an “ink-pack-end”, i.e., a state where almost no ink remains in the ink pack 110, is detected in the middle of an operation consuming ink. If the amount of ink actually consumed in an operation corresponds to the minimum value of the tolerance, the soft count value and the amount of ink actually consumed are different by ±15%.

Thus, if 973 ml is counted as a soft count value, the amount of ink actually consumed is 719 ml (973 ml÷1.15 33 0.85=719 ml) at its minimum.

Further, as described above, the brand-new ink pack 110 mounted on the recording apparatus 1000 according to the present exemplary embodiment may contain 1,020 ml of ink. Thus, when the notification of no remaining ink is displayed on the recording apparatus 1000 according to the present exemplary embodiment of the present disclosure, the amount of ink remaining in the ink pack 110 is 301 ml (1,020 ml−719 ml=301 ml) at its maximum of the ink amount in the brand-new ink pack 110. As described above, if the soft count alone is performed, a maximum of 301 ml of ink can remain in the ink pack 110 when the notification of no remaining ink is displayed. This amount, i.e., 301 ml, is approximately 30% of the amount of ink stored in the brand-new ink pack 110, i.e., approximately 1,000 ml.

A description will be also given of the amount of ink likely to remain in the ink pack 110 when the notification of no remaining ink is displayed when the amount of ink remaining in the ink pack 110 is detected through the sequence of detecting the amount of remaining ink according to the present exemplary embodiment.

As described above, if the detected amount of ink remaining in the ink pack 110 corresponds to an amount less than the predetermined amount through the sequence of detecting the amount of remaining ink in step S413, the amount of ink remaining in the ink bag 111 is 100 ml to 200 ml. At this time, “100 ml” is stored as the remaining amount in the soft counters, and the soft count is started in step S423. From this point forward, in consideration of an amount of ink of 7 ml for the recovery operation that will consume ink the most, the amount of ink consumed based on the soft count is 93 ml (100 ml−7 ml−93 ml) at its minimum of the amount of ink in the brand-new ink pack 110. Thus, when 93 ml is counted as a soft count value, the amount of ink actually consumed is 69 ml (93 ml÷1.15×0.85=69 ml) at its minimum of the amount of ink in the brand-new ink pack 110.

On the other hand, if the amount of ink remaining in the ink pack 110 is detected less than the predetermined amount through the sequence of detecting the amount of remaining ink in step S413, the maximum amount of ink remaining in the ink bag 111 is 200 ml. Thus, the amount of ink likely to remain in the ink pack 110 when the notification of no remaining ink is displayed on the display unit in step S424 is 131 ml (200 ml−69 ml=131 ml) at its maximum of the amount of ink in the brand-new ink pack 110. This amount corresponds to approximately 13% of the amount of ink in the brand-new ink pack 110, i.e., approximately 1,000 ml.

As described above, detection values can be significantly different between in the case of a calculation of the amount of ink with the soft count alone and in the case of a calculation based on the sequence of detecting the amount of remaining ink with the detection sensor according to the present exemplary embodiment. Specifically, when the notification of no remaining ink is displayed, the amount of ink remaining in brand-new ink packs 110 is approximately 30% detected with the soft count and approximately 13% with the detection sensor according to the present exemplary embodiment, allowing a 17% decrease. This can calculate the amount of ink remaining in the ink pack 110 more accurately.

A second exemplary embodiment of the present disclosure will now be described. The description of a configuration similar to that described in the first exemplary embodiment is omitted.

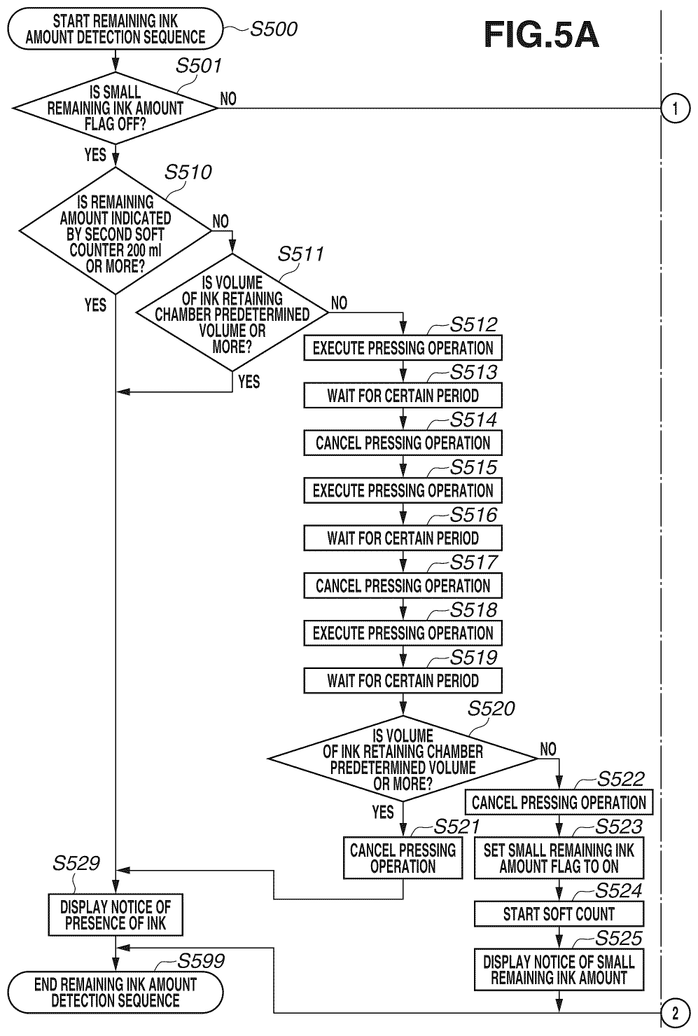

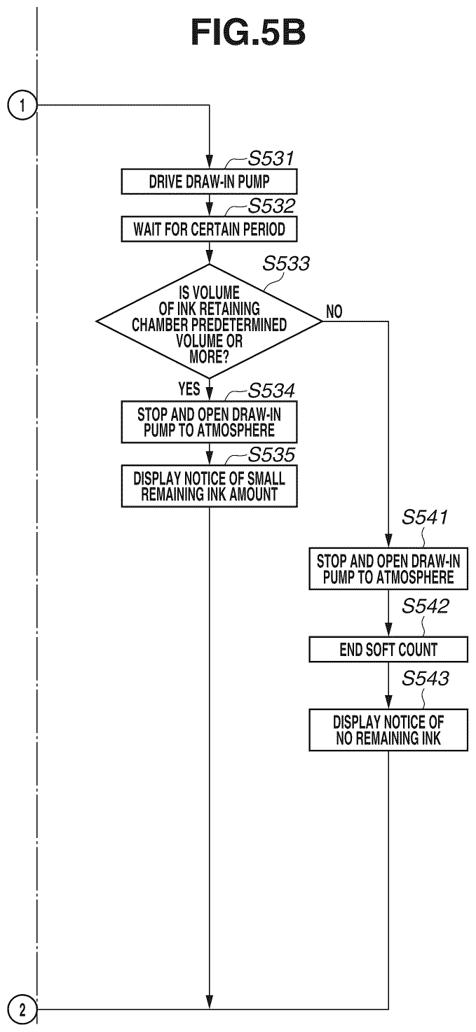

FIG. 5 is a flowchart illustrating a sequence of detecting the amount of remaining ink according to the present exemplary embodiment. Similarly to the sequence described in the first exemplary embodiment, this sequence is executed before an operation consuming ink, such as an operation for sucking/discharging ink from the discharge ports of the recording head 10. In the sequence of detecting the amount of remaining ink according to the present exemplary embodiment, the soft count is started at the time when a brand-new ink pack 110 is installed into the recording apparatus 1000. The count value of the soft count is stored in an area (hereinafter, referred to a “second soft counter”) different from the areas (the soft counters) in the RAM 202 and the NVRAM 204. In the sequence of detecting the amount of remaining ink according to the present exemplary embodiment, the areas (the soft counters) in the RAM 202 and the NVRAM 204 for the soft count in the first exemplary embodiment are also used similarly to the case in the first exemplary embodiment. Further, similarly to the first exemplary embodiment, the maximum value of tolerance is used as the amount of ink consumed in an operation for the soft count.

After the sequence of detecting the amount of remaining ink is started in step S500, the processing proceeds to step S501. In step S501, the processing is performed for determining whether a flag indicating a small amount of remaining ink is off. If the flag indicating a small amount of remaining ink is off, e.g., the determination result in step S501 is “YES” (YES in step S501), the processing proceeds to step S510.

In step S510, the processing is performed for determining whether the value of the amount indicated by the second soft counter is 200 ml or more. If the value of the amount indicated by the second soft counter is 200 ml or more, e.g., the determination result is “YES” (YES in step S510), the processing proceeds to step S529. In step S529, a notification of a sufficient amount of remaining ink is displayed on the display unit of the recording apparatus 1000. In step S599, the sequence of detecting the amount of remaining ink is ended.

If the value of the amount indicated by the second soft counter is less than 200 ml, e.g., the determination result is “NO” (NO in step S510), the processing proceeds to step S511. In step S511, the processing is performed for determining whether the volume of the ink retaining chamber 130 is a predetermined volume or more. If the volume of the ink retaining chamber 130 is the predetermined volume or more, e.g., the determination result in step S511 is “YES” (YES in step S511), the processing proceeds to step S529. In step S529, the notification of a sufficient amount of remaining ink is displayed on the display unit of the recording apparatus 1000. In step S599, the sequence of detecting the amount of remaining ink is ended.

If the volume of the ink retaining chamber 130 is less than the predetermined volume, e.g., the determination result in step S511 is “NO” (NO in step S511), the processing proceeds to step S512. In step S512, similarly to the first exemplary embodiment, pressure is applied on the ink bag 111 by the pressing mechanism. Specifically, the pressing mechanism causes the rotating cam 162 to be rotated by a half turn from the bottom dead point to the top dead point, pressing the ink bag 111 using the pressing plate 161.

After the processing in step S512 ends, in step S513, a waiting time takes 0.5 seconds. In step S514, the pressure applied in step S512 is released. Specifically, the pressing mechanism causes the rotating cam 162 to be rotated by a half turn from the top dead point to the bottom dead point, releasing the pressure on the ink bag 111.

After the processing in step S514 ends, the processing proceeds to step S515. In step S515, the pressing operation is performed again. In step S516, a waiting time takes a certain period of time. In step S517, the pressing operation is cancelled. In addition, a waiting time takes 0.5 seconds in step S516. However, the length of the waiting time can be set as appropriate. In step S518, pressure is applied on the ink bag 111 again. In step S519, a waiting time takes a certain period of time, and the processing proceeds to step S520. In step S519, a waiting time takes 0.5 seconds. However, the length of the waiting time can be set as appropriate. In other words, the pressing operation is performed three times in steps S512 to S519 before determination processing is performed in step S520.

In step S520, the processing is performed for determining whether the volume of the ink retaining chamber 130 is a predetermined volume or more. If the volume of the ink retaining chamber 130 is the predetermined volume or more when the ink is pushed out of the ink bag 111 by the pressing operation being performed three times in steps S512 to S519, e.g., the determination result in step S520 is “YES” (YES in step S520), the processing proceeds to step S521.

In step S521, the rotating cam 162 is rotated by a half turn from the top dead point to the bottom dead point, releasing the pressure applied in step S518. Thereafter, the processing proceeds to step S529. In step S529, the notification of a sufficient amount of remaining ink is displayed on the display unit of the recording apparatus 1000. In step S599, the sequence of detecting the amount of remaining ink is ended.

If the volume of the ink retaining chamber 130 is not the predetermined volume or more even by the pressing operation being performed three times in steps S512 to S519, e.g., the determination result in step S520 is “NO” (NO in step S520), the processing proceeds to step S522. If ink contained in the ink bag 111 is hardly pushed to the ink retaining chamber 130 even by the pressing operation being performed three times, a small amount of ink remains in the ink bag 111. At this time, the amount of ink remaining in the ink bag 111 is 100 ml to 150 ml.

In step S522, similarly to the processing in step S521, the pressure on the ink bag 111 is released. In step S523, a flag indicating a small amount of remaining ink is set to on. In step S524, similarly to the processing in step S423 of the first exemplary embodiment, the soft count is started, and the count value of the soft count is stored in the soft counters. At this time, “100 ml” is stored as a remaining amount in the soft counters. After the processing in step S524 ends, the processing proceeds to step S525. In step S525, the notification of a small amount of remaining ink is displayed on the display unit of the recording apparatus 1000. In step S599, the sequence of detecting the amount of remaining ink is ended.

When an operation consuming ink is performed after the end of the sequence of detecting the amount of remaining ink, the amount of ink consumed during the operation is calculated with the soft count, and the count value stored in the soft counters is updated to a new one by subtracting the value of the calculated amount of the ink consumed from the stored count value.

If the flag indicating a small amount of remaining ink is on, e.g., the determination result in step S501 is “NO” (NO in step S501), the processing proceeds to step S531, and the processing in step S531 and the subsequent steps are performed. More specifically, the processing in steps S531 to S543 is performed. The pieces of processing in steps S531 to S543 is similar to those in steps S431 to S443 described in the first exemplary embodiment, and the descriptions thereof are omitted.

When an operation consuming ink is performed after the end of the sequence of detecting the amount of remaining ink, processing is performed for checking whether the amount of ink consumed during the operation exceeds the count value stored in the soft counters before the operation. If the amount of ink consumed exceeds the count value, the operation is not started. Further, the notification of no remaining ink is displayed on the display unit of the recording apparatus 1000 according to the present disclosure.

As described above, the sequence of detecting the amount of remaining ink according to the present exemplary embodiment can reduce the amount of ink remaining in the ink pack 110 more than that according to the first exemplary embodiment. A specific effect produced by the present exemplary embodiment will be described.

Similarly to the first exemplary embodiment, when the soft count alone is performed, the maximum of ink remaining in the ink pack 110 when the notification of no remaining ink is displayed is 301 ml.

This amount corresponds to approximately 30% of the amount of ink in the brand-new ink pack 110, i.e., approximately 1,000 ml.

On the other hand, as described above, when a small amount of ink remaining in the ink pack 110 is detected through the sequence of detecting the amount of remaining ink in step S523 according to the present exemplary embodiment, the amount of ink remaining in the ink bag 111 is 100 ml to 150 ml. At this time, “100 ml” is stored as the remaining amount in the soft counters. In other words, from this point forward, similarly to the case described in the first exemplary embodiment, the amount of ink consumable based on the soft count is 93 ml (100 ml−7 ml=93 ml) at its minimum of the ink amount in the brand-new ink pack 110. In the recording apparatus 1000 according to the present exemplary embodiment, the amount of ink consumed in the operation consuming ink the most of the operations which are not instantly stopped halfway through is also 7 ml as in the first exemplary embodiment.

Further, similarly to the first exemplary embodiment, when 93 ml is counted as a soft count value, the amount of ink actually consumed is 69 ml (93 ml÷1.15×0.85=69 ml) at its minimum of the amount of ink in the brand-new ink pack 110. Further, in the present exemplary embodiment, 150 ml of ink may remain in the ink bag 111 when a small amount of ink remaining in the ink pack 110 is detected. Thus, the amount of ink remaining in the ink pack 110, when the recording apparatus 1000 according to the present exemplary embodiment displays the notification of no remaining ink, is 81 ml (150 ml−69 ml=81 ml) at its maximum of the amount of ink in the ink pack 110. An amount of 81 ml corresponds to approximately 8% of the amount of ink in the brand-new ink pack 110, i.e., approximately 1,000 ml.

As described above, when the notification of no remaining ink is displayed, the sequence of detecting the amount of remaining ink according to the present exemplary embodiment can reduce the maximum amount of ink remaining in the ink pack 110 more than that according to the first exemplary embodiment. Specifically, according to the first exemplary embodiment, the amount of ink corresponding to approximately 13% of the amount of ink in the brand-new ink pack 110 is likely to remain in the ink pack 110. In contrast, according to the present exemplary embodiment, the amount of remaining ink can be reduced to the amount of ink corresponding to approximately 8% of the amount of ink in the brand-new ink pack 110. Thus, the amount of ink remaining in the ink pack 110 can be calculated more accurately.

A third exemplary embodiment of the present disclosure will be described. The descriptions of the configurations similar to those in the first and the second exemplary embodiments are omitted.

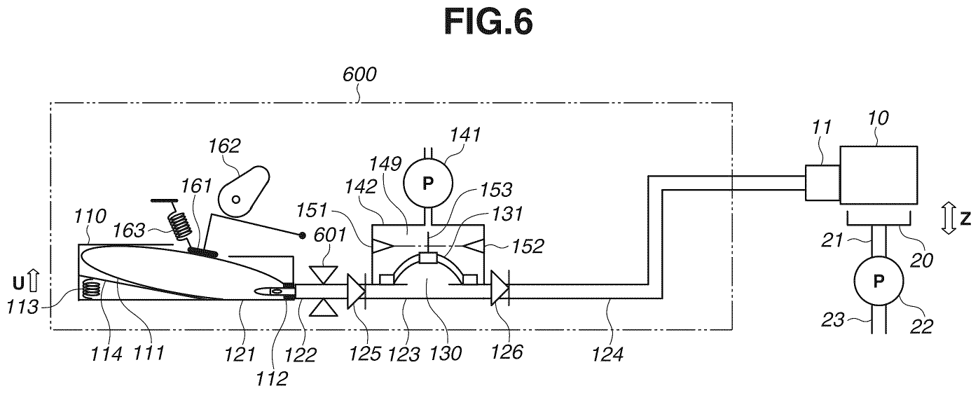

FIG. 6 is a schematic diagram illustrating a recording apparatus 1000 according to the present exemplary embodiment. In FIG. 6, the same reference numbers as those in FIG. 1 refer to the elements similar to those illustrated in FIG. 1, and the descriptions thereof are omitted. In the present exemplary embodiment, pigment ink is used as the ink contained in the ink bag 111 supplied to the recording head 10. Pigment ink contains a pigment component, and the pigment is precipitated to cause an uneven pigment concentration of the ink when left as it is. If recording is performed on a recording medium by the recording head 10 with an uneven pigment concentration of the ink, the uneven pigment concentration can affect the level of image quality, calling for equalization of the pigment concentration of the ink.

The recording apparatus 1000 according to the present exemplary embodiment includes an opening/closing valve 601 on the first ink supply flow path 122. The opening/closing valve 601 can block the first ink supply flow path 122. FIG. 6 illustrates a case where the opening/closing valves 601 does not block the first ink supply flow path 122.

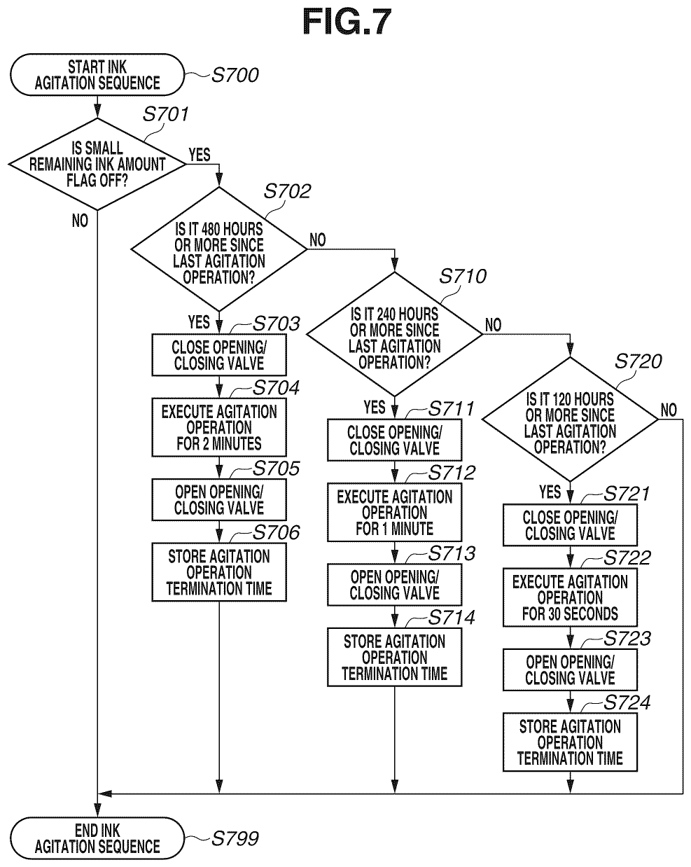

FIG. 7 is a flowchart illustrating a sequence of ink agitation according to the present exemplary embodiment. The sequence of ink agitation is executed at the time when the power of the recording apparatus 1000 is turned on and at regular time intervals. In the present exemplary embodiment, the sequence of ink agitation is executed every 4 hours, except for the power-off period and operating periods, such as a printing operation and a recovery operation. When the sequence of ink agitation is started in step S700, firstly, the processing proceeds to step S701. In step S701, the processing is performed for determining whether the flag indicating a small amount of remaining ink is off. The flag indicating a small amount of remaining ink is switched between on and off through the sequence of detecting the amount of remaining ink described in the first or the second exemplary embodiment.

If the flag indicating a small amount of remaining ink is off and the notification of a small amount of remaining ink is displayed on the display unit of the recording apparatus 1000, e.g., the determination result in step S701 is “YES” (YES in step S701), the processing proceeds to step S702. In step S702, the processing is performed for determining whether the time elapse since the last agitation operation (the details are described below) is 480 hours (i.e., 20 days). If the determination result is “YES” (YES in step S702), the processing proceeds to step S703.

In step S703, the opening/closing valve 601 is closed, blocking the first ink supply flow path 122. After the first ink supply flow path 122 is blocked, the processing proceeds to step S704. In step S704, an agitation operation is performed for 2 minutes. Specifically, in the operation, the rotating cam 162 is rotated by one turn and a waiting time takes 0.5 seconds. This operation is repeated approximately eighty times. The repeated pressing operations and pressing cancelling operations on the ink bag 111 agitate the ink in the ink bag 111, reducing the unevenness in pigment concentration in the ink bag 111 due to precipitation of the pigment. In addition, the time taken to cause the rotating cam 162 to be rotated by one turn is 1 second. Further, the waiting time and the rotation speed of the rotating cam 162 can be set as appropriate.

After the processing in step S704 is ended, the processing proceeds to step S705. In step S705, the opening/closing valve 601 is opened. In other words, the blocked state of the first ink supply flow path 122 is cleared. In step S706, the termination time of the agitation operation performed in step S704 is stored in the NVRAM 204. Then, in step S799, the sequence of ink agitation is ended.

If the time elapse since the last agitation operation is less than 480 hours, e.g., the determination result in step S702 is “NO” (NO in step S702), the processing proceeds to step S710. In step S710, the processing is performed for determining whether the time elapse since the last agitation operation is 240 hours (i.e., 10 days) or more. If the determination result is “YES” (YES in step S710), the processing proceeds to step S711. In step S711, the opening/closing valve 601 is closed. Then, the processing proceeds to step S712. In step S712, an agitation operation similar to that in step S704 is performed for 1 minute. In step S713, the opening/closing valve 601 is opened. In step S714, the termination time of the agitation operation in step S712 is stored. In step S799, the sequence of ink agitation is ended.

If the time elapse since the last agitation operation is less than 240 hours, e.g., the determination result in step S710 is “NO” (NO in step S710), the processing proceeds to step S720. In step S720, the processing is performed for determining whether the time elapse since the last agitation operation is 120 hours (i.e., 5 days) or more. If the determination result is “YES” (YES in step S720), the processing proceeds to step S721. In step S721, the opening/closing valve 601 is closed. Then, the processing proceeds to step S722. In step S722, an agitation operation similar to that described above is performed for 30 seconds. In step S723, the opening/closing valve 601 is opened. In step S724, the termination time of the agitation operation in step S722 is stored. In step S799, the sequence of ink agitation is ended.

If the time elapse since the lase agitation operation is less than 120 hours, e.g., the determination result in step S720 is “NO” (NO in step S720), the processing proceeds to step S799, and the sequence of ink agitation is ended. In addition, the lengths of time as criteria of determination in steps S702, S710, and S720 can be changed as appropriate depending on the properties of the ink, the volume of the ink pack 110, or the environment, such as the temperature. Further, the lengths of time an agitation operation is continued in steps S704, S712, and S722 can also be changed as appropriate.

If the flag indicating a small amount of remaining ink is on, e.g., the determination result in step S701 is “NO” (NO in step S701), the processing proceeds to step S799. In step S799, the sequence of ink agitation is ended without an agitation operation. This is because the height in the gravitational direction of the ink bag 111 is low as illustrated in FIG. 3C with the flag indicating a small amount of remaining ink on. Thus, an uneven pigment concentration in the ink bag 111 will not have a significant effect on recording performed by the recording head 10 even if the pigment is precipitated.

As described above, if the time elapse since the last agitation operation is 5 days and the recording apparatus 1000 is in a power-on state, the recording apparatus 1000 according to the present exemplary embodiment performs an agitation operation for 30 seconds. However, as described above, an agitation operation is not necessarily performed with the flag indicating a small amount of remaining ink on. Further, when an operation, such as a printing operation or a recovery operation, is being performed at that time, an agitation operation is performed after the end of the operation. Furthermore, in the ink pack 110 replacement, the time elapse since the last replacement time is used for determinations in steps S702, S710, and S720 instead of the time elapse since the last agitation operation.

Whether an agitation operation is performed for one minute varies depending on the timing of the last agitation operation. However, the one-minute agitation operation is performed when the recording apparatus 1000 according to the present exemplary embodiment in a power-off state for 5 to 10 days is brought into a power-on state. Similarly, a two-minute agitation operation is performed depending on the timing of the last agitation operation, and the timing is when the recording apparatus 1000 in a power-off state for 15 to 20 days is brought into a power-on state.

The above-described configuration, even if pigment ink in which one component is apt to precipitate is stored in the ink bag 111, equalizes the pigment concentration of the ink through agitation operations, reducing the effect on recording performed by the recording head 10.

### Other Exemplary Embodiments

As a sensor for detecting whether the volume of the ink retaining chamber 130 is a predetermined volume or more, a detection sensor which includes a photo-interrupter as a main constituent element is used for the recording apparatus 1000 according to the first to the third exemplary embodiments. However, the invention is not limited to the above-described exemplary embodiments, and another detection sensor can be used which detects contact/non-contact between electrodes by measuring the electric resistance.

Further, as a pressing unit for pressing the ink bag 111 from the outside, a pressing mechanism is employed which includes the pressing plate 161, the rotating cam 162, and the pressure releasing spring 163 as main constituent elements for the recording apparatus 1000 according to the first to the third exemplary embodiments. However, the invention is not limited to the above-described exemplary embodiments, and a pressing unit in another form which presses the ink bag 111 using air pressure from the outside of the ink bag 111, for example, can be employed.

The present disclosure can be applied to an apparatus different from a recording apparatus which consumes liquid. Thus, the present disclosure can also be applied to an apparatus which consumes a liquid that does not include a color material, such as a reaction liquid.

According to the present disclosure, the amount of ink in an ink pack can be detected more accurately.

While the present disclosure has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-197727, filed Nov. 21, 2023, which is hereby incorporated by reference herein in its entirety.

What is claimed is:

1. A liquid supply apparatus comprising:
a deformable liquid containing member configured to contain a liquid to be supplied to a liquid discharge head for discharging the liquid to a recording medium;
a liquid supply flow path for supplying the liquid to the liquid discharge head from the liquid containing member;
a liquid retaining chamber disposed on the liquid supply flow path and configured to let the liquid flow into the liquid discharge head from the liquid containing member by changing a volume of the liquid containing member;
a liquid draw-in unit configured to draw the liquid into the liquid retaining chamber from the liquid containing member by reducing a pressure of a space outside the liquid retaining chamber to cause the volume of the liquid retaining chamber to be expanded;
a pressing unit configured to press the liquid containing member from the outside; and
a control unit configured to perform a control to display a first display on a display unit in a case where the volume of the liquid retaining chamber is less than a predetermined amount when the pressing unit presses the liquid containing member, and to display a second display on the display unit in a case where the volume of the liquid retaining chamber is less than the predetermined amount when the liquid draw-in unit reduces a pressure of the space.

2. The liquid supply apparatus according to claim 1, wherein the first display is configured to indicate that a small amount of the liquid is contained in the liquid containing member, and the second display is configured to indicate that no liquid is contained in the liquid containing member.

3. The liquid supply apparatus according to claim 1, wherein the pressing unit is configured to shift between at a pressing position where the pressing unit presses to deform the liquid containing member and at a pressure releasing position where the pressing unit does not press the liquid containing member.

4. The liquid supply apparatus according to claim 1, further comprising:
a detection unit configured to receive light emitted from a light emission unit with a light receiving unit,
wherein the liquid retaining chamber includes a light blocking unit configured to move based on change of the volume, and
wherein, the detection unit is configured to detect that the volume of the liquid retaining chamber is a predetermined amount or more when the light blocking unit blocks the light emitted from the light emitting unit through expansion of the volume of the liquid retaining chamber.

5. The liquid supply apparatus according to claim 3, wherein the pressing unit is configured to be repeatedly shifted between at the pressing position and at the pressure releasing position to perform an agitation of the liquid contained in the liquid containing member.

6. The liquid supply apparatus according to claim 5, wherein the pressure unit is configured to not perform the agitation is in a case where the control unit displays the first display on the display unit.
